(19) United States
(12) Patent Application Publication
(10) Pub. No.: US 2020/0362130 A1
(43) Pub. Date: Nov. 19, 2020

(54) STRETCHED POROUS FILM AND MANUFACTURING METHOD THEREFOR

(71) Applicant: TOKUYAMA CORPORATION, Yamaguchi (JP)

(72) Inventors: Nobuyuki TANAKA, Yamaguchi (JP); Tetsuya IMURA, Yamaguchi (JP); Kunio KAMATA, Yamaguchi (JP)

(21) Appl. No.: 16/766,655

(22) PCT Filed: Nov. 30, 2018
(86) PCT No.: PCT/JP2018/044253

§ 371 Date: May 22, 2020

(30) Foreign Application Priority Data
Nov. 30, 2017 (JP) 2017-231180

(51) Int. Cl. C08J 9/00; C08J 5/18; B29C 48/00; B29C 48/08; B29C 55/06

(52) U.S. Cl. CPC C08J 9/0066; C08J 5/18; B29C 48/0018; B29C 48/08; B29K 2021/003; C08J 2323/06; C08J 2425/08; B29K 2023/06; B29C 55/06

(57) ABSTRACT

An object of the present invention is to provide a stretched porous film having all of air permeability, water resistance, and flexibility. A stretched porous film in accordance with an embodiment of the present invention contains a resin composition containing a specific polyethylene-based resin and a thermoplastic elastomer at a certain mass ratio, and has a water vapor transmission rate of not less than 1400 g/m·.24 h.

### TECHNICAL FIELD

The present invention relates to a stretched porous film and a method for producing the stretched porous film.

### BACKGROUND ART

Conventionally, a personal care product such as a diaper is required to have an ability to let air, water vapor, and the like pass through the personal care product but not let liquid pass through the personal care product, in order to prevent a damp feel and the like. As such, it has been a requirement that a personal care product such as a diaper have air permeability and water resistance. To meet the requirement, a porous film that is a film into which a water-repellent resin such as a polyolefin-based resin is formed and which has fine holes is in use. The porous film has a structure that lets air and the like pass through the porous film but does not let liquid pass through the porous film.

Patent Literature 1 discloses an air-permeable film which consists of a resin composition containing: a polyethylene-based resin having a specific density, melting point, and MFR; an olefin-based thermoplastic elastomer; an inorganic filler; and a plasticizer, and exhibits a certain range of strength when stretched by 20% in a transverse direction and a certain range of residual strain after being stretched by 50%.

Patent Literature 2 discloses an air-permeable elastic film containing: a high-performance elastomer such as a styrene-based block copolymer; and a low-performance elastomer, such as polyolefin, which is filled with a plurality of particles that are suitable for formation of fine holes in the film in a state where the film is stretched into a thin film.

### CITATION LIST

### Patent Literature

[Patent Literature 1]

Japanese Patent Application Publication, Tokukai, No. 2017-31292

[Patent Literature 2]

Japanese Translation of PCT International Application, Tokuhyo, No. 2003-515619

### SUMMARY OF INVENTION

### Technical Problem

However, the above air-permeable films have room for improvement in terms of air permeability, water resistance, and flexibility.

An aspect of the present invention is accomplished in view of the above problem. An object of the aspect of the present invention is to provide a stretched porous film having all of air permeability, water resistance, and flexibility and thus being suitable for use in personal care products such as diapers.

### Solution to Problem

In order to attain the above object, the inventors of the present invention conducted diligent research, and found that it is possible to provide a stretched porous film having all of air permeability, water resistance, and flexibility, by (i) using a resin composition containing a specific polyethylene-based resin and a thermoplastic elastomer in a specific mass ratio and (ii) adjusting a water vapor transmission rate to fall within a specific range. Specifically, the present invention includes the following configurations.

A stretched porous film containing a resin composition, the resin composition containing: a polyethylene-based resin having a density of not less than 0.900 g/cm³ and not more than 0.940 g/cm³; not less than 1.0 parts by mass and not more than 16 parts by mass of a thermoplastic elastomer relative to 100 parts by mass of the polyethylene-based resin; and an inorganic filler, the stretched porous film having a water vapor transmission rate of not less than 1400 g/m²·24 h as measured at 40° C. and at a relative humidity of 60% in accordance with ASTM E96.

A method for producing a stretched porous film, including: a mixing step of mixing (i) a polyethylene-based resin having a density of not less than 0.900 g/cm³ and not more than 0.940 g/cm³, (ii) not less than 1.0 parts by mass and not more than 16 parts by mass of a thermoplastic elastomer relative to 100 parts by mass of the polyethylene-based resin, and (iii) an inorganic filler to prepare a resin composition; a forming step of forming the resin composition into the form of a film; and a porosification step of stretching, at least in a machine direction, the film obtained by the forming step to porosify the film.

### Advantageous Effects of Invention

An aspect of the present invention makes it possible to provide a stretched porous film having all of air permeability, water vapor permeability, and flexibility.

### DESCRIPTION OF EMBODIMENTS

The following description will discuss an embodiment of the present invention. Note, however, that the present invention is not limited to such an embodiment.

The inventors conducted diligent research and found that the foregoing conventional techniques have the following issues. For example, Patent Literature 1 states that the technique disclosed in Patent Literature 1 has flexibility and stretchability. However, the technique disclosed in Patent Literature 1 involves using a large amount of the thermoplastic elastomer. As a result, the air permeability shows an extremely high value (15000 sec/100 ml), and still shows a value as high as 8000 sec/100 ml even in a case where stretching is carried out at a high stretch ratio. It is therefore likely that a diaper and the like produced using the technique disclosed in Patent Literature 1 have poor air permeability and are prone to give a damp feel.

Further, the technique disclosed in Patent Literature 2 uses, as a low-performance elastomer, a polyethylene plastomer or a polyolefin plastomer each having a density of less than 0.900 g/cm³. This is likely to lower the melting point of a resin composition and cause the following problems when heat fixation is carried out. Firstly, in a case where heat fixation is not carried out, the film which has been wound into a roll form gradually becomes tighter and is thus likely to undergo blocking. Secondly, in a case where heat fixation is carried out at an optimum temperature, there is a smaller difference between the melting point and a heat fixation, so that the resin composition may remelt. Remelting of the film causes holes which have been formed to be blocked, and thus deteriorates the air permeability. In a case where the heat fixation temperature is lowered, on the other hand, the film which has been would into a roll form gradually becomes tighter and is thus likely to undergo blocking, as with the case in which heat fixation is not carried out.

Under such circumstances, a stretched porous film in accordance with an embodiment of the present invention is to solve the above issues accompanying the conventional techniques, and has all of air permeability, water vapor permeability, and flexibility. The following description discusses the details.

[1. Stretched Porous Film]A stretched porous film in accordance with an embodiment of the present invention is a stretched porous film containing a resin composition, the resin composition containing: a polyethylene-based resin having a density of not less than 0.900 g/ cm³ and not more than 0.940 g/cm³; not less than 1.0 parts by mass and not more than 16 parts by mass of a thermoplastic elastomer relative to 100 parts by mass of the polyethylene-based resin; and an inorganic filler, the stretched porous film having a water vapor transmission rate of not less than 1400 g/m²·24 h as measured at 40° C. and at a relative humidity of 60% in accordance with ASTM E96. By thus combining the polyethylene-based resin having a certain physical property with a thermoplastic elastomer at a certain mass ratio, it is possible to achieve desired flexibility as well as water resistance. Further, adjusting the water vapor transmission rate to fall within a certain range enables achieving desired air permeability. Accordingly, it becomes possible to provide a stretched porous film having all of air permeability, water resistance, and flexibility.

Note that the stretched porous film may consist of the resin composition containing the polyethylene-based resin, the thermoplastic elastomer, and the inorganic filler. Alternatively, the stretched porous film may include, for example, a sheet or the like that is made of a material different from the resin composition and is provided on top of a layer of the resin composition.

<1-1. Polyethylene-Based Resin>

The above polyethylene-based resin has a density of not less than 0.900 g/cm³ and not more than 0.940 g/cm³, preferably not less than 0.905 g/cm³ and not more than 0.935 g/cm³. In a case where the density of the polyethylene-based resin is within the above range, combining the polyethylene-based resin with the thermoplastic elastomer (described later) yields a stretched porous film having desired flexibility. Further, density and melting point are correlated with each other to some extent. In a case where the density of the polyethylene-based resin is within the above range, a heat fixation temperature differs from the melting point to some extent. This enables preventing the polyethylene-based resin from melting simultaneously with heat fixation to cause blocking of holes in the stretched porous film. It is thus possible to prevent a decrease in air permeability.

Examples of the polyethylene-based resin include linear low-density polyethylene (LLDPE), branched low-density polyethylene (LDPE), and very-low-density polyethylene (VLDPE). Note that it is preferable to use a plurality of kinds of polyethylene, since use of the plurality of kinds of polyethylene facilitates adjustment of melt mass flow rate. By thus adjusting the melt mass flow rate of the polyethylene-based resin to be substantially equal to the melt mass flow rate of the thermoplastic elastomer, it is possible to stably pelletize the resin composition. For example, the polyethylene-based resin may be a combination of (i) the linear low-density polyethylene or the very-low-density polyethylene and (ii) the branched low-density polyethylene. Note that, in a case of using a mixture of a plurality of kinds of resins as the polyethylene-based resin, the mixture may be a polyethylene-based resin having a density of more than 0.940 g/cm³ (e.g., high-density polyethylene (HDPE)). In such a case, the density of the entire polyethylene-based resin which is used (the density of the mixture of the plurality of kinds of polyethylene-based resins) needs only be not more than 0.940 g/cm³. More preferably, all of the polyethylene-based resins to be used have respective densities each falling within the above range.

<1-2. Thermoplastic Elastomer>

The thermoplastic elastomer is added for the purpose of improving flexibility. A proportion of the thermoplastic elastomer relative to 100 parts by mass of the polyethylene-based resin is preferably not less than 1.0 part by mass and not more than 16 parts by mass, more preferably not less than 1.5 parts by mass and not less than 14 parts by mass, even more preferably not less than 2.0 parts by mass and not more than 12 parts by mass. In a case where the proportion of the thermoplastic elastomer is not less than 1.0 part by mass, it is possible to impart more flexibility to the stretched porous film. In a case where the proportion of the thermoplastic elastomer is not more than 16 parts by mass, it is possible to increase a strength of the stretched porous film. Further, in a case where the proportion of the thermoplastic elastomer is not more than 16 parts by mass, it is possible to inhibit an occurrence of draw resonance and thereby improve productivity.

The thermoplastic elastomer is preferably an olefin-based elastomer and/or a styrene-based elastomer.

Examples of the olefin-based elastomer include: a mixture of a polymer consisting of a hard segment and a polymer consisting of a soft segment; a copolymer of a polymer consisting of a hard segment and a polymer consisting of a soft segment; and the like. Examples of the hard segment include a segment consisting of polypropylene, and the like. Examples of the soft segment include: a segment consisting of polyethylene; a segment consisting of a copolymer of ethylene and a small amount of a diene component; or the like. Specifically, examples of the soft segment include: an ethylene-propylene copolymer (EPM), an ethylene-propylene-diene copolymer (EPDM); a material obtained by partial crosslinking of EPDM by adding an organic peroxide to the EPDM; and the like.

Further, the mixture of copolymers serving as the olefin-based elastomer and the copolymer may be respectively a mixture and a copolymer which have been modified by graft polymerization with use of an unsaturated hydroxy monomer and a derivative thereof, an unsaturated carboxylic acid monomer and a derivative thereof, or the like.

Examples of the olefin-based elastomer include “THERMORUN” manufactured by Mitsubishi Chemical Corporation, “EXCELINK” manufactured by JSR Corporation, “ESPOLEX TPE” manufactured by Sumitomo Chemical Co., Ltd., “Milastomer” manufactured by Mitsui Chemicals, Inc., “Sarlink” manufactured by Teknor Apex, “Santoprene” manufactured by ExxonMobil Chemical, “ACTYMER G” manufactured by RIKEN TECHNOS CORPORATION, and the like.

Examples of the styrene-based elastomer include a styrene-based elastomer that includes (i) a polystyrene block as a hard segment and (ii) any of various kinds blocks such as a polybutadiene block, a polyisoprene block, a polyethylene-polybutene block, or a polyethylene-polypropylene block as a soft segment. That is, examples of the styrene-based elastomer include a styrene-butadiene block copolymer, a styrene-isoprene block copolymer, a styrene-ethylene-butene block copolymer, a styrene-ethylene-propylene block copolymer, and the like.

Examples of the styrene-based elastomer include

“RABARON” manufactured by Mitsubishi Chemical Corporation, “ESPOLEX SB” manufactured by Sumitomo Chemical Co., Ltd., “Tuftec” manufactured by Asahi Kasei Corporation, “Elastomer AR” manufactured by ARONKASEI CO., LTD., “SEPTON” manufactured by KURARAY CO., LTD., “EARNESTON” manufactured by KURARAY PLASTICS CO., Ltd., and the like.

Note that the above commercially available thermoplastic elastomer products may in fact be a mixture containing a thermoplastic elastomer and another component (e.g., polypropylene, a paraffin-based oil, and the like). Such a product can be used such that an amount of the thermoplastic elastomer contained in the product accounts for the above-described proportion relative to 100 parts by mass of the polyethylene-based resin.

That is, the resin composition may contain polypropylene, a paraffin-based oil, and the like. Further, the resin composition may contain a paraffin-based oil as a result of use of a thermoplastic elastomer containing the paraffin-based oil as described above. Alternatively, the resin composition may contain a thermoplastic elastomer containing no paraffin-based oil and separately contain a paraffin-based oil. In a case where the resin composition contains a paraffin-based oil, it is possible to further improve the flexibility of the stretched porous film. A content of the paraffin-based oil is preferably 2 parts by mass to 18 parts by mass relative to 100 parts by mass of the polyethylene-based resin.

<1-3. Inorganic Filler>

The inorganic filler is added for the purpose of porosifying the film. The inorganic filler may be any well-known inorganic filler without limitation. Examples of the inorganic filler include: an inorganic salt such as calcium carbonate, barium sulfate, calcium sulfate, barium carbonate, magnesium hydroxide, and aluminum hydroxide; an inorganic oxide such as zinc oxide, magnesium oxide, and silica; a silicate such as mica, vermiculite, and talc; and an organic metal salt. Among the examples of the inorganic filler, calcium carbonate is preferable from the viewpoint of cost performance and dissociability from the polyethylene-based resin.

In the resin composition, a mixing ratio of the inorganic filler to 100 parts by mass of a total of the polyethylene-based resin and the thermoplastic elastomer is preferably not less than 80 parts by mass and not more than 200 parts by mass, more preferably not less than 85 parts by mass and not more than 150 parts by mass. In a case where the mixing ratio of the inorganic filler is not less than 80 parts by mass, it is possible to increase a frequency of voids per unit area, which voids are formed as a result of dissociation of the polyethylene-based resin and the inorganic filler from each other. Accordingly, voids that are in close proximity to each other are connected to each other more easily, whereby air permeability is improved. In a case where the mixing ratio of the inorganic filler is not more than 200 parts by mass, the film has good stretchability and thus is easily stretched.

<1-4. Other Components>

The resin composition may further contain an additive that is used in an ordinary resin composition. Examples of the additive include an antioxidant, a thermal stabilizer, a photo stabilizer, an ultraviolet absorber, a neutralizer, a lubricant, an anti-clouding agent, an anti-blocking agent, an antistatic agent, a slipping agent, a coloring agent, a plasticizer, and the like. Note that the resin composition may contain a small amount of a resin component other than resin components included in the polyethylene-based resin and the thermoplastic elastomer, provided that the resin component does not impair the effects of the present invention. Specifically, addition of the other resin component is permissible provided that the amount of the other resin component is not more than 5.0 parts by mass, more preferably not more than 2.5 parts by mass relative to 100 parts by mass of the total of the polyethylene-based resin and the thermoplastic elastomer.

<1-5. Physical Properties of Stretched Porous Film>

The water vapor transmission rate of the stretched porous film is preferably not less than 1400 g/m²·24 h, more preferably not less than 1600 g/m²·24 h. In a case where the water vapor transmission rate is within the above range, the stretched porous film is excellent in air permeability and water vapor permeability. For example, in a case where the stretched porous film is used as a back sheet of a disposable diaper, it is possible to prevent a damp feel while the diaper is worn. Note that there is no particular upper limit to the water vapor transmission rate, but the water vapor transmission rate is preferably not more than 10000 g/m²·24 h, more preferably not more than 5000 g/m²·24 h from the viewpoint of mechanical characteristics, water resistance, and liquid leakage resistance.

The water vapor transmission rate is measured at 40° C. and a relative humidity of 60% for a measurement time of 24 hours under the conditions of a pure water method in accordance with ASTM E96. Note that as used herein, “water vapor transmission rate” is an average value of water vapor transmission rates of 10 samples in a size of 10 cm×10 cm taken from the stretched porous film.

A strength at 5% stretch of the stretched porous film, which is a strength of the stretched porous film when stretched by 5%, is preferably not less than 0.3 N/25 mm and not more than 2.5 N/25 mm, more preferably not less than 0.5 N/25 mm and not more than 2.3 N/25 mm. The stretched porous film is more flexible as the strength at 5% stretch decreases. In a case where the strength at 5% stretch is not more than 2.5 N/25 mm, it is possible to impart more flexibility to the stretched porous film. In a case where the strength at 5% stretch is not less than 0.3 N/25 mm, it is possible to reduce stretching of the film caused by a line tension exerted in the machine direction during secondary processing.

The strength at 5% stretch is a strength of a sample of the stretched porous film as measured when the sample has been stretched by 5% by being pulled in the machine direction in accordance with JIS K 7127 with a chuck-to-chuck distance of 50 mm and at a pulling speed of 200 mm/min. That is, the strength at 5% stretch is a stress in the machine direction as measured when the chuck-to-chuck distance has increased by 2.5 mm. Note that as used herein, “strength at 5% stretch” is a value measured with respect to a sample of 25 mm in width and 150 mm in length in the machine direction taken from the stretched porous film.

A melt mass flow rate of the resin composition is preferably not less than 2.0 g/10 min, more preferably not less than 2.0 g/10 min and not more than 5.0 g/10 min, even more preferably not less than 2.0 g/10 min and not more than 4.0 g/10 min. In a case where the melt mass flow rate is within the above range, it is possible to carry out more stable film formation. In a case where the melt mass flow rate is not less than 2.0 g/10 min, it is possible to reduce a resin pressure of an extruder during film production and thereby prevent an adverse effect on the film production. In a case where the melt mass flow rate is not more than 5.0 g/10 min, it is possible to further reduce neck-in during film production with use of a T-die. This enables easily achieving a required product width. Note that the strength at 5% stretch tends to increase as the melt mass flow rate decreases. The melt mass flow rate of the resin composition is measured at 190° C. with use of an A method in accordance with JIS K 7210.

An air permeability of the stretched porous film is preferably not less than 300 seconds/100 ml and not more than 2000 seconds/100 ml, more preferably not less than 400 seconds/100 ml and not more than 1600 seconds/100 ml, even more preferably not less than 400 seconds/100 ml and not more than 1100 seconds/100 ml. The smaller the value of the air permeability, the easier it is for gas to pass through the stretched porous film. An air permeability within the above range enables preventing a damp feel when a disposable diaper in which the stretched porous film is used as a back sheet is worn. The air permeability is measured by an Oken-type air permeability tester method in accordance with JIS P 8117.

A thermal shrinkage rate of the stretched porous film in the machine direction is preferably not more than 5.0%, more preferably not more than 3.5%. In a case where the strength at 5% stretch is high and the thermal shrinkage rate in the machine direction is not more than 5.0%, it is possible to further reduce stretching of the film caused by a line tension exerted in the machine direction during secondary processing. The thermal shrinkage rate in the machine direction is preferably as close to 0% as possible but in practice is not less than 0.5%.

The thermal shrinkage rate in the machine direction is measured in the following manner. A sample in a size of 15 cm×15 cm is taken from the stretched porous film. Lines are marked on the sample such that a distance between the marked lines along the machine direction is 10 cm. The sample is left for 24 hours at 50° C. and then cooled down to a room temperature, and a distance between the marked lines is measured. The thermal shrinkage rate in the machine direction is calculated by the following formula I.

Thermal shrinkage rate in machine direction (%)={(10cm −Distance between marked lines after cooling (cm))/10 cm}×100 (I)

The stretched porous film has a weight per unit area of preferably not less than 10 g/m² and not more than 35 g/m², more preferably not less than 11 g/m² and not more than 32 g/m², even more preferably not less than 12 g/m² and not more than 30 g/m². In a case where the weight per unit area is within the above range, it is possible to provide a stretched porous film that is excellent in air permeability, water vapor permeability, and mechanical strength. In a case where the weight per unit area is not less than 10 g/m², it is possible to increase the mechanical strength of the film. In a case where the weight per unit area is not more than 35 g/m², it is possible to achieve sufficient water vapor permeability.

A blocking strength (also referred to as “peel strength”) is preferably not more than 1.0 N/1000 mm². In a case where the blocking strength is not more than 1.0 N/1000 mm², portions of the film which portions overlap with each other when the film is stored in a roll form are relatively easily peeled off from each other, and thus it is easy to handle the film. The blocking strength is measured in the following manner. Two samples each in a size of 25 mm×80 mm are taken from the stretched porous film. The samples are placed so as to overlap with each other by 40 mm to be used as a test piece. In a constant temperature/humidity chamber, the test piece is left for 24 hours at a temperature of 40° C. and a relative humidity of 70% in a state where a load of 10 kg is applied to an overlapping portion of the test piece. After 24 hours, the test piece is cooled down to a room temperature, and a blocking strength is determined with use of a tension testing machine.

[2. Method for Producing Stretched Porous Film]

A method for producing a stretched porous film in accordance with an embodiment of the present invention includes: a mixing step of mixing (i) a polyethylene-based resin having a density of not less than 0.900 g/cm³ and not more than 0.940 g/cm³, (ii) not less than 1.0 parts by mass and not more than 16 parts by mass of a thermoplastic elastomer relative to 100 parts by mass of the polyethylene-based resin, and (iii) an inorganic filler to prepare a resin composition; a forming step of forming the resin composition into the form of a film; and a porosification step of stretching, at least in a machine direction, the film obtained by the forming step to porosify the film. By thus combining the polyethylene-based resin having a certain physical property with the thermoplastic elastomer at a certain mass ratio, it is possible to provide a stretched porous film having desired flexibility as well as water resistance. Further, by stretching the film containing the resin composition having a specific composition, it is possible to provide a stretched porous film having desired air permeability. Accordingly, it becomes possible to provide a stretched porous film having all of air permeability, water resistance, and flexibility. Note that description of matters which have been already described in [1. Stretched porous film] will be omitted below and the foregoing description will be employed as necessary.

<2-1. Mixing Step>

The mixing step is a step of mixing (i) a polyethylene-based resin having a density of not less than 0.900 g/cm³ and not more than 0.940 g/cm³, (ii) not less than 1.0 parts by mass and not more than 16 parts by mass of a thermoplastic elastomer relative to 100 parts by mass of the polyethylene-based resin, and (iii) an inorganic filler to prepare a resin composition. First, the polyethylene-based resin, the thermoplastic elastomer, the inorganic filler, and optionally an additive are mixed together. A method for mixing is not particularly limited, and may be a well-known method. For example, it is preferable to carry out the mixing with use of a mixer such as a Henschel mixer, a super mixer, a tumbler mixer, or the like for approximately 5 minutes to 1 hour. At this time, in a case where the respective melt flow rates of the polyethylene-based resin and the thermoplastic elastomer are substantially equal to each other, stable pelletization is achieved. It is therefore preferable to adjust the respective melt mass flow rates of the polyethylene-based resin and the thermoplastic elastomer to be substantially equal to each other.

The resultant mixture can be generally kneaded and pelletized by a method such as strand cutting, hot cutting, or underwater cutting with use of a high-level-kneading twin-screwed extruder or a kneader such as a tandem kneader. Conducting mixing and kneading in advance before pelletizing enables uniform dispersion of the resin composition and therefore is preferable. Alternatively, depending on the composition of the resin composition, the above ingredients may be directly supplied into the kneader without mixing and be pelletized.

<2-2. Forming Step>

The forming step is a step of forming the resin composition into the form of a film. It is preferable that the pellet obtained as described above be formed into the form of a film with use of a circular die or a T-die mounted on a tip of an extruder. In a case of using the T-die method, a method for cooling is not particularly limited, and may be a well-known method such as a nip-rolling method, an air knife method, or an air chamber method. Note that depending on the composition of the resin composition, it is possible to supply the resin composition directly into the extruder without mixing and kneading and form the resin composition into the film.

<2-3. Porosification Step>

The porosification step is a step of stretching, at least in a machine direction, the film obtained by the forming step to porosify the film. Stretching the film obtained by the forming step causes a resin component (the polyolefin-based resin and the thermoplastic elastomer) and the inorganic filler to be separated from each other at an interface therebetween. Minute voids are created at the interface at which the resin component and the inorganic filler have been separated from each other, and these voids form a continuous hole which passes through the film in a thickness direction of the film. Thus, the stretched porous film is obtained. The stretching can be performed by a well-known method such as a roller stretching method or a tenter stretching method. Further, the stretching may be uniaxial stretching or biaxial stretching.

Note that a stretch magnification at which the film is stretched in the machine direction in the porosification step is preferably represented by the following formula II:

1.4≤Y≤0.075X+2.5 (II)

where X represents a mixing ratio (parts by mass) of the thermoplastic elastomer to 100 parts by mass of the polyethylene-based resin and Y represents a stretch magnification (times).

Performing the stretching under conditions that satisfy the formula II allows the film to be sufficiently stretched, thereby reducing the occurrence of non-uniformity in thickness and also increasing tear strength. As a result, a sufficient number of holes that are adequate in size are formed. Thus, having such a specific stretch magnification makes it possible to provide more easily a stretched porous film having all of air permeability, water vapor permeability, and flexibility. The stretching may be single-stage stretching or multi-stage stretching.

A stretching temperature is preferably in a temperature range of not lower than a room temperature and lower than a softening point of the resin composition. A stretching temperature of not lower than the room temperature makes it less likely for the stretching to be uneven, and thus makes it easier to achieve a uniform thickness. Further, a stretching temperature of lower than the softening point enables preventing the stretched porous film from melting. This makes it possible to prevent the holes in the stretched porous film from being deformed and thus prevent deterioration of the air permeability and the water vapor permeability. The stretching temperature can be adjusted as appropriate by altering a combination of the physical properties of the resin composition and the stretch magnification to be employed.

<2-4. Heat Fixation Step>

The method for producing a stretched porous film may include a heat fixation step. The heat fixation step is a step of heat fixing the stretched porous film which has been stretched, in order to reduce thermal shrinkage in a stretching direction. Heat fixation refers to a heat treatment to which a film that has been stretched is subjected (i) in an environment that does not cause a change in dimensions and (ii) in a state where a tense state of the film resulting from the stretching is maintained. Accordingly, the heat fixation enables reducing elastic recovery during storage, thermally-caused shrinkage and tightening, and the like.

In a case of employing the roller stretching method as the stretching method, the heat fixation may be carried out by, for example, a method in which a film that has been stretched is heated by a heated roller (anneal roller). In a case of employing the tenter stretching method as the stretching method, the heat fixation may be carried out by, for example, a method in which a film that has been stretched is heated by in the vicinity of an outlet of the tenter.

A heat fixation temperature is preferably not lower than 70° C. and not higher than 95° C., more preferably not lower than 80° C. and not higher than 95° C. In a case where the heat fixation temperature is not lower than 70° C., it is possible to carry out sufficient heat fixation and thus reduce thermal shrinkage. In a case where the heat fixation temperature is not higher than 95° C., it is possible to better prevent deformation of the holes in the stretched porous film by heat.

A heat fixation time is preferably not less than 0.2 seconds, more preferably not less than 0.5 seconds, even more preferably not less than 1.0 seconds. In a case where the heat fixation time is not less than 0.2 seconds, it is possible to carry out sufficient heat fixation and thus reduce thermal shrinkage. Further, the heat fixation time is preferably not more than 20 seconds, more preferably not more than 15 seconds. Although the preferred heat fixation time varies depending on the heat fixation temperature employed in combination with the heat fixation, a heat fixation time of not more than 20 seconds enables better preventing deformation of the holes in the stretched porous film by melting of the stretched porous film. Thus, it possible to prevent deterioration of the air permeability and the water vapor permeability.

The heat fixation time is a time during which the stretched porous film is maintained at the heat fixation temperature. For example, in a case where the roller stretching method is employed, the heat fixation time refers to a time during which the film is in contact with the anneal roller. The number of anneal rollers is not particularly limited, but in a case where two or more anneal rollers are used, the heat fixation time is a sum of times during which the respective anneal rollers are in contact with the stretched porous film. Further, in a case where the tenter stretching method is employed, the heat fixation time is a time during which the film is heated and maintained at the heat fixation temperature in the vicinity of the outlet of the tenter. In a case where the heat fixation is divided into a plurality of heating sessions, the heat fixation time is a sum of times of the respective heating sessions.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in more detail based on Examples. Note, however, that the present invention is not limited to such Examples.

[Evaluation Method]

Physical property values of each of stretched porous films in accordance with the Examples and the Comparative Examples, which will be described later, were measured in the following manner.

(1) Melt Mass Flow Rate

A melt mass flow rate of the resin composition was measured by the A method in accordance with JIS K 7210, selecting 190° C. as a measurement temperature. Note that the melt mass flow rate will be hereinafter referred to as MI (melt index).

(2) Weight Per Unit Area

A sample in a size of 10 cm×10 cm was cut out from the stretched porous film, and a mass of the sample was measured with use of a balance. From an area and the mass of the sample, a weight per unit area was calculated.

(3) Water Vapor Transmission Rate

Ten samples each in a size of 10 mm×10 mm were taken from the stretched porous film. Water vapor transmission rates of the respective samples were measured at 40° C. and a relative humidity of 60% for a measurement time of 24 hours under the conditions of the pure water method in accordance with ASTM E96, and an average value of the water vapor transmission rates was calculated.

(4) Air Permeability

An air permeability was measured by the Oken-type air permeability tester method in accordance with JIS P 8117.

(5) Strength at 5% Stretch

A sample of 25 mm in width and 150 mm in length in a machine direction was taken from the stretched porous film in accordance with JIS K 7127. As a strength at 5% stretch, a strength of the sample was measured when the sample was stretched by 5% by being pulled in the machine direction with a chuck-to-chuck distance of 50 mm and at a pulling speed of 200 mm/min. That is, a stress in the machine direction when the chuck-to-chuck distance increased by 2.5 mm was measured.

(6) Thermal Shrinkage Rate in Machine Direction

A sample in a size of 15 cm×15 cm was taken from the stretched porous film. Lines were marked on the sample such that a distance between the marked lines along the machine direction was 10 cm. The sample was left for 24 hours at 50° C. and then cooled down to a room temperature, and a distance between the marked lines was measured. A thermal shrinkage rate in the machine direction was calculated by the following formula (formula I).

Thermal shrinkage rate in the machine direction (%)={(10 cm−Distance between the marked lines after cooling (cm))/10 cm}×100 (I)

(7) Blocking Strength

Two samples each in a size of 25 mm×80 mm were taken from the stretched porous film. The samples were placed so as to overlap with each other by 40 mm to be used as a test piece. In a constant temperature/humidity chamber, the test piece was left for 24 hours at a temperature of 40° C. and a relative humidity of 70% in a state where a load of 10 kg was applied to an overlapping portion of the test piece. After 24 hours, the test piece was cooled down to a room temperature, and a blocking strength was determined with use of a tension testing machine.

[Components Used]

A: Linear low-density polyethylene [manufactured by The Dow Chemical Company, product name: DOWLEX 2047, density: 0.917 g/cm³, MI: 2.3 g/10 min]

B: Linear low-density polyethylene [manufactured by The Dow Chemical Company, product name: DOWLEX 2035G, density: 0.919 g/cm³, MI: 6.0 g/10 min]

C: Linear low-density polyethylene [manufactured by The Dow Chemical Company, product name: DOWLEX 2036P, density: 0.935 g/cm³, MI: 2.5 g/10 min]

D: Linear low-density polyethylene [manufactured by The Dow Chemical Company, product name: DOWLEX 2045G, density: 0.920 g/cm³, MI: 1.0 g/10 min]

E: Very-low-density polyethylene [manufactured by Tosoh Corporation, product name: Lumitac 22-7, density: 0.900 g/cm³, MI: 2.0 g/10 min]

F: Very-low-density polyethylene [manufactured by Tosoh Corporation, product name: Lumitac 43-1, density: 0.905 g/cm³, MI: 8.0 g/10 min]

G: Very-low-density polyethylene [manufactured by Mitsui Chemicals, Inc., product name: TAFMER A-4085S, density: 0.885 g/cm³, MI: 3.6 g/10 min]

H: High-density polyethylene [manufactured by Tosoh Corporation, product name: Nipolon Hard 4200, density: 0.961 g/cm³, MI: 2.3 g/10 min]

I: High-density polyethylene [manufactured by Japan Polyethylene Corporation, product name: NOVATEC HD HF560, density: 0.963 g/cm³, MI: 7.0 g/10 min]

J: Branched low-density polyethylene [manufactured by Du Pont-Mitsui Polychemicals Co., Ltd., product name: Mirason 16P, density: 0.917 g/cm³, MI: 3.7 g/10 min]

K: Branched low-density polyethylene [manufactured by Asahi Kasei Chemicals Corporation, product name: L1850K, density: 0.918 g/cm³, MI: 6.8 g/10 min]

L: Thermoplastic elastomer [JSR Corporation, product name: EXCELINK 1301 N, density: 0.880 g/cm³, MI: 7.0 g/10 min]

M: Thermoplastic elastomer [KURARAY PLASTICS CO., Ltd., product name: EARNESTON JG2ONS, density: 0.890 g/cm³, MI: 2.6 g/10 min]

N: Thermoplastic elastomer [KURARAY PLASTICS CO., Ltd., product name: EARNESTON JS2ON, density: 0.890 g/cm³, MI: 15 g/10 min]

O: Thermoplastic elastomer [KURARAY CO., LTD., product name: SEPTON 2063, density: 0.880 g/cm³, MI: 0.4 g/10 min]

P: Calcium carbonate [manufactured by IMERYS Minerals, product name: FL-520]

Q: Barium sulfate [manufactured by Sakai Chemical Industry Co., Ltd., product name: BARIACE B-54]

R: Additive [a mixture of 50% by mass of titanium oxide (manufactured by HUNTSMAN, product name: TR28), 20% by mass of a hindered phenol-based thermal stabilizer (manufactured by Ciba Japan K.K., product name: IRGANOX3114), and 30% by mass of a phosphorus-based thermal stabilizer (manufactured by Ciba Japan K.K., product name: IRGAFOS 168)].

### Example 1

Polyethylenes, a thermoplastic elastomer, an inorganic filler, and an additive written in Tables 1 and 2 were mixed together to prepare a resin composition. The resin composition was granulated, and then film formation was carried out.

The granulation (preparation of pellets) was carried out in the following manner. With use of a 30-mm diameter twin-screwed extruder having a vent, the resin composition was extruded into the form of strands at a cylinder temperature of 180° C., and was cooled in a water tank. Then, the resin composition thus extruded was cut into pieces of approximately 5 mm and dried to prepare pellets.

Subsequently, a film was formed out of the pellets with use of a 400-mm diameter T-die film formation machine. Note that a lip clearance was 1.5 mm, a die temperature was 230° C., an air gap was 105 mm, a take-off speed was 10 m/min, and a cast roller temperature was 20° C. The film thus obtained was further subjected to uniaxial stretching (stretch magnification: 1.8 times) only in a machine direction with use of a roller stretching machine which had been set to 40° C., and then was subjected to in-line annealing with use of a heat-setting roller which has been set to 90° C. (heat fixation time: 4 seconds). A thermal shrinkage rate in the machine direction when the heat fixation was carried out was 8%.

### Examples 2 through 18 and Comparative Examples 1 through 6

In Examples 2 through 18 and Comparative Examples 1 through 6, a film was formed in the same manner as Example 1 except that a mixing ratio of components or a stretching condition (stretch magnification or heat fixation temperature) was changed as shown in Table 1.

TABLE 1

| | | | | | | | | | | | | Density of |
|---|---|---|---|---|---|---|---|---|---|---|---|---|
| | Polyethylene-based resin: mixing ratio | | | | | | | | | | | entire |
| | (% by mass) | | | | | | | | | | | polyethylene- |
| | LLDPE | | | | VLDPE | | | HDPE | | LDPE | | based resin |
| | A | B | C | D | E | F | G | H | I | J | K | (g/cm³) |
| Ex. 1 | 30 | 42 | — | — | — | — | — | — | — | 28 | — | 0.918 |
| Ex. 2 | 31 | 45 | — | — | — | — | — | — | — | 24 | — | 0.918 |
| Ex. 3 | 29 | 41 | — | — | — | — | — | — | — | 30 | — | 0.918 |
| Ex. 4 | — | — | — | — | 31 | 44 | — | — | — | 25 | — | 0.906 |
| Ex. 5 | — | — | — | — | 31 | 45 | — | — | — | 24 | — | 0.906 |
| Ex. 6 | 31 | 45 | — | — | — | — | — | — | — | 24 | — | 0.918 |
| Ex. 7 | 73 | — | — | — | — | — | — | — | — | 27 | — | 0.917 |
| Ex. 8 | 31 | 45 | — | — | — | — | — | — | — | 24 | — | 0.918 |
| Ex. 9 | 31 | 45 | — | — | — | — | — | — | — | — | 24 | 0.918 |
| Ex. 10 | 31 | 45 | — | — | — | — | — | — | — | 24 | — | 0.918 |
| Ex. 11 | 44 | — | 28 | — | — | — | — | — | — | 28 | — | 0.922 |
| Ex. 12 | 46 | — | — | — | — | — | — | 27 | — | 27 | — | 0.929 |
| Ex. 13 | — | — | — | — | 30 | 43 | — | — | — | 27 | — | 0.907 |
| Ex. 14 | — | — | — | — | 30 | 43 | — | — | — | 27 | — | 0.907 |
| Ex. 15 | 31 | 45 | — | — | — | — | — | — | — | 24 | — | 0.918 |
| Ex. 16 | 31 | 45 | — | — | — | — | — | — | — | 24 | — | 0.918 |
| Ex. 17 | 31 | 45 | — | — | — | — | — | — | — | 24 | — | 0.918 |
| Ex. 18 | 29 | 41 | — | — | — | — | — | — | — | 30 | — | 0.918 |
| Comp. | 31 | 45 | — | — | — | — | — | — | — | 24 | — | 0.918 |
| Ex. 1 | | | | | | | | | | | | |
| Comp. | 31 | 45 | — | — | — | — | — | — | — | 24 | — | 0.918 |
| Ex. 2 | | | | | | | | | | | | |
| Comp. | — | — | — | — | — | — | — | 31 | 45 | 24 | | 0.951 |
| Ex. 3 | | | | | | | | | | — | | |
| Comp. | — | — | — | — | — | — | 75 | — | — | 25 | — | 0.893 |
| Ex. 4 | | | | | | | | | | | | |
| Comp. | 31 | — | — | 45 | — | — | — | — | — | 24 | — | 0.918 |
| Ex. 5 | | | | | | | | | | | | |
| Comp. | 31 | 45 | — | — | — | — | — | — | — | 24 | — | 0.918 |
| Ex. 6 | | | | | | | | | | | | |

TABLE 2

| | | | | | Raw material: mixing | | | Resin | |
|---|---|---|---|---|---|---|---|---|---|
| | Thermoplastic | | | | ratio (parts by mass) | | | com- | |
| | elastomer | | | | Calcium | | | posi- | Stretch- |
| | mixing ratio | | | | carbon- | Barium | Addi- | tion MI | ing |
| | (parts by mass) | | | | ate | sulfate | tive | (g/10 | condi- |
| | L | M | N | O | P | Q | R | min) | tion |
| Ex. 1 | 8.0 | — | — | — | 135 | — | 2.0 | 2.3 | *1 |
| Ex. 2 | 4.0 | — | — | — | 124 | — | 2.0 | 2.3 | *1 |
| Ex. 3 | 11 | — | — | — | 142 | — | 2.0 | 2.3 | *1 |
| Ex. 4 | 4.0 | — | — | — | 135 | — | 2.0 | 2.2 | *1 |
| Ex. 5 | 2.0 | — | — | — | 130 | — | 2.0 | 2.5 | *1 |
| Ex. 6 | — | 3.0 | — | — | 125 | — | 2.0 | 3.2 | *1 |
| Ex. 7 | — | — | 5.0 | — | 143 | — | 2.0 | 2.5 | *1 |
| Ex. 8 | — | — | — | 12 | 115 | — | 2.0 | 2.4 | *1 |
| Ex. 9 | 4.0 | — | — | — | 124 | — | 2.0 | 2.6 | *1 |
| Ex. 10 | 4.0 | — | — | — | 124 | — | 2.0 | 2.3 | *2 |
| Ex. 11 | — | — | 5.0 | — | 149 | — | 2.0 | 2.4 | *1 |
| Ex. 12 | — | — | 5.0 | — | 143 | — | 2.0 | 2.4 | *1 |
| Ex. 13 | 8.0 | — | — | — | — | 134 | 2.0 | 2.2 | *1 |
| Ex. 14 | 8.0 | — | — | — | 134 | — | 2.0 | 2.3 | *1 |
| Ex. 15 | 4.0 | — | — | — | 124 | — | 2.0 | 2.3 | *3 |
| Ex. 16 | — | — | — | 9.0 | 115 | — | 2.0 | 2.7 | *1 |
| Ex. 17 | — | 2.0 | — | 6.0 | 120 | — | 2.0 | 2.8 | *1 |
| Ex. 18 | 11 | — | — | — | 142 | — | 2.0 | 2.3 | *3 |
| Comp. | — | — | — | — | 115 | — | 2.0 | 2.5 | *1 |
| Ex. 1 | | | | | | | | | |
| Comp. | 18 | — | — | — | 155 | — | 2.0 | 2.5 | *1 |
| Ex. 2 | | | | | | | | | |
| Comp. | 4.0 | — | — | — | 124 | — | 2.0 | 2.3 | *1 |
| Ex. 3 | | | | | | | | | |
| Comp. | 4.0 | — | — | — | 135 | — | 2.0 | 2.0 | *4 |
| Ex. 4 | | | | | | | | | |
| Comp. | 4.0 | — | — | — | 124 | — | 2.0 | 1.0 | *1 |
| Ex. 5 | | | | | | | | | |
| Comp. | 4.0 | — | — | — | 124 | — | 2.0 | 2.3 | *5 |
| Ex. 6 | | | | | | | | | |

Note that “Polyethylene-based resin: mixing ratio (% by mass)” indicates a mixing ratio of polyethylenes to 100% by mass of the polyethylene-based resin contained in the resin composition. “Mixing ratio (parts by mass)” of the thermoplastic elastomer indicates a mixing ratio of the thermoplastic elastomer relative to 100 parts by mass of the polyethylene-based resin. Further, L, M, and N used in the present Examples are each a thermoplastic elastomer mixture containing not only a thermoplastic elastomer but also a component (e.g., a paraffin-based oil) other than the thermoplastic elastomer. As such, the mixing ratio of each thermoplastic elastomer in Table 2 indicates a mixing ratio of a thermoplastic elastomer component calculated on the basis of a published mixing ratio of each product. A mixing ratio of each of calcium carbonate, barium sulfate, and an additive written in Table 2 is relative to 100 parts by mass of a total of the polyethylene-based resin and the thermoplastic elastomer.

Further, a stretching condition *1 indicates a stretch magnification of 1.8 times and a heat fixation temperature of 90° C. A stretching condition *2 indicates a stretch magnification of 2.3 times and a heat fixation temperature of 90° C. A stretching condition *3 indicates a stretch magnification of 3.2 times and a heat fixation temperature of 90° C. A stretching condition *4 indicates a stretch magnification of 1.8 times and a heat fixation temperature of 60° C. A stretching condition *5 indicates a stretch magnification of 1.3 times and a heat fixation temperature of 90° C.

[Results]

The stretched porous films obtained in Examples 1 through 18 and Comparative Examples 1 through 6 were measured in terms of weight per unit area, water vapor transmission rate, air permeability, strength at 5% stretch, and thermal shrinkage rate. Measured results are shown in Table 3.

TABLE 3

| | Physical properties of film | | | | | |
|---|---|---|---|---|---|---|
| | Weight | Water | Air | | | |
| | per | vapor | per- | | Thermal | |
| | unit | transmis- | meabil- | Strength at | shrinkage | |
| | area | sion rate | ity | 5% stretch | rate | |
| | (g/m²) | (g/m² · 24 h) | (s/100 ml) | (N/25 mm) | (%) | Note |
| Ex. 1 | 18 | 1,850 | 600 | 1.3 | 2.8 | |
| Ex. 2 | 18 | 2,050 | 550 | 1.7 | 2.0 | |
| Ex. 3 | 15 | 1,450 | 1,050 | 0.8 | 3.0 | |
| Ex. 4 | 18 | 1,750 | 600 | 1.3 | 3.0 | |
| Ex. 5 | 18 | 1,950 | 500 | 1.5 | 3.0 | |
| Ex. 6 | 18 | 1,450 | 1,100 | 1.8 | 2.0 | |
| Ex. 7 | 18 | 1,900 | 500 | 1.2 | 3.0 | |
| Ex. 8 | 18 | 2,000 | 500 | 2.0 | 2.5 | |
| Ex. 9 | 18 | 1,750 | 600 | 1.4 | 1.6 | |
| Ex. 10 | 18 | 2,550 | 400 | 1.9 | 1.5 | |
| Ex. 11 | 18 | 2,250 | 450 | 1.3 | 2.5 | |
| Ex. 12 | 18 | 1,550 | 950 | 1.7 | 3.2 | |
| Ex. 13 | 18 | 1,500 | 1,050 | 1.5 | 4.0 | |
| Ex. 14 | 18 | 1,950 | 500 | 0.8 | 3.0 | |
| Ex. 15 | 18 | 2,600 | 300 | 2.8 | 1.5 | |
| Ex. 16 | 18 | 1,850 | 600 | 2.2 | 2.0 | |
| Ex. 17 | 18 | 1,700 | 650 | 1.8 | 2.0 | |
| Ex. 18 | 18 | 1,700 | 650 | 2.4 | 2.5 | |
| Comp. | 18 | 1,950 | 500 | 2.9 | 2.0 | |
| Ex. 1 | | | | | | |
| Comp. | 18 | — | — | — | — | *6 |
| Ex. 2 | | | | | | |
| Comp. | 18 | 3,400 | 100 | 2.9 | 3.2 | |
| Ex. 3 | | | | | | |
| Comp. | 18 | 2,600 | 250 | 0.7 | 13.8 | |
| Ex. 4 | | | | | | |
| Comp. | 18 | 1,200 | 1,300 | 1.8 | 2.7 | |
| Ex. 5 | | | | | | |
| Comp. | 18 | 200 | 4,000 | 1.6 | 2.0 | |
| Ex. 6 | | | | | | |

Note that “Note *6” indicates that a draw resonance occurred.

The stretched porous films of Examples 1 through 18 each exhibited a good water vapor transmission rate of not less than 1400 g/ m²·24 h and had a good texture. Further, the stretched porous films of Examples 1 through 18 each had a low value of strength at 5% stretch and a low value of thermal shrinkage rate.

Note that a comparison of Examples 1 through 3 indicates that as the mixing ratio of the thermoplastic elastomer decreases, the water vapor transmission rate increases and the air permeability and the thermal shrinkage rate decrease. Further, a comparison of Examples 4 and 5 also indicates that as the mixing ratio of the thermoplastic elastomer decreases, the water vapor transmission rate increases and the air permeability decreases.

A comparison of Example 2 and Examples 6 and 9 indicates that Example 2, which had a lower melt mass flow rate, had a higher water vapor transmission rate and a lower air permeability.

A comparison of Examples 2 and 10 indicates that Example 10, which had a higher stretch magnification, had a higher water vapor transmission rate, a lower air permeability, and a lower thermal shrinkage rate.

A comparison of Examples 3 and 18 indicates that, as with the comparison of Examples 2 and 10, Example 18, which had a higher stretch magnification, had a higher water vapor transmission rate, a lower air permeability, and a lower thermal shrinkage rate.

Examples 11 and 12 used respective polyethylene resins that differed from each other in density. Polyethylene having a density of 0.961 g/cm³ was used in Example 12. Example 12, in which the polyethylene having the higher density was added, had a lower water vapor transmission rate and a higher air permeability than Example 11. Further, Example 12 had a higher strength at 5% stretch. However, there is no problem with these results, and Example 12 was excellent in heat resistance.

Examples 13 and 14 used respective different inorganic fillers. Barium sulfate has a high specific gravity, and a volume ratio of the inorganic filler per unit volume of the resin composition was therefore small. Accordingly, fewer holes were formed in Example 13 than in Example 14. As such, Example 14 had a higher water vapor transmission rate and a lower air permeability than Example 13. Further, Example 13 had a higher volume ratio of the resin component, and therefore had a higher stress during stretching. Accordingly, Example 13 had a higher strength at 5% stretch.

Note that Example 15, which had a stretch magnification not satisfying the formula II, had a higher strength at 5% stretch than Examples 1 through 14 and 16 through 18 each of which had a stretch magnification satisfying the formula II. However, Example 15 exhibited a better strength at 5% stretch than Comparative Examples.

A comparison of Examples 8 and 16 indicates that Example 8, in which the amount of the thermoplastic elastomer was higher than Example 16, had a higher water vapor transmission rate and a lower air permeability. Further, due to the increase in the amount of the thermoplastic elastomer, Example 8 had a lower strength at 5% stretch. A comparison of Examples 16 and 17 indicates that Example 17, in which a paraffin-based oil was contained, had a lower strength at 5% stretch.

Comparative Example 1 used no thermoplastic elastomer. This resulted in a stretched porous film having a higher strength at 5% stretch and poor flexibility.

In Comparative Example 2, the thermoplastic elastomer was used in a large amount, so that a draw resonance occurred. This inhibited evaluation of physical properties.

In Comparative Example 3, a polyethylene-based resin which as a whole had a density of more than 0.940 g/cm³ was used. This resulted in a stretched porous film having a higher strength at 5% stretch and poor flexibility. In Comparative Example 4, a polyethylene-based resin having a density of less than 0.900 g/cm³ was used. This resulted in a stretched porous film having a high thermal shrinkage rate.

In each of Comparative Examples 5 and 6, a stretched porous films obtained had a low water vapor transmission rate and thus had a poor air permeability.

Aspects of the present invention can also be expressed as follows:

[1] A stretched porous film containing a resin composition, the resin composition containing: a polyethylene-based resin having a density of not less than 0.900 g/cm³ and not more than 0.940 g/cm³; not less than 1.0 parts by mass and not more than 16 parts by mass of a thermoplastic elastomer relative to 100 parts by mass of the polyethylene-based resin; and an inorganic filler, the stretched porous film having a water vapor transmission rate of not less than 1400 g/m²·24 h as measured at 40° C. and at a relative humidity of 60% in accordance with ASTM E96.

[2] The stretched porous film as set forth in [1], wherein the thermoplastic elastomer is an olefin-based elastomer and/ or a styrene-based elastomer.

[3] The stretched porous film as set forth in [1] or [2], wherein the stretched porous film has a strength in a machine direction of not less than 0.3 N/25 mm and not more than 2.5 N/25 mm as measured when pulling the stretched porous film in the machine direction in accordance with JIS K 7127 with a chuck-to-chuck distance of 50 mm and at a pulling speed of 200 mm/min has increased the chuck-to-chuck distance by 5%.

[4] The stretched porous film as set forth in any one of [1] through [3], wherein the resin composition has a melt mass flow rate of not less than 2.0 g/10 min as measured at 190° C. in accordance with JIS K 7210.

[5] The stretched porous film as set forth in any one of [1] through [4], wherein the stretched porous film has an air permeability of not less than 300 sec/100 ml and not more than 2000 sec/100 ml as measured by Oken-type air permeability tester method in accordance with JIS P 8117.

[6] The stretched porous film as set forth in any one of [1] through [5], wherein the resin composition further contains a paraffin-based oil.

[7] A method for producing a stretched porous film, including: a mixing step of mixing (i) a polyethylene-based resin having a density of not less than 0.900 g/cm³ and not more than 0.940 g/cm³, (ii) not less than 1.0 parts by mass and not more than 16 parts by mass of a thermoplastic elastomer relative to 100 parts by mass of the polyethylene-based resin, and (iii) an inorganic filler to prepare a resin composition; a forming step of forming the resin composition into the form of a film; and a porosification step of stretching, at least in a machine direction, the film obtained by the forming step to porosify the film.

[8] The method as set forth in [7], wherein a stretch magnification at which the film is stretched in the machine direction in the porosification step is represented by the following formula II:

1.4≤Y≤0.075X+2.5 (II)

where X represents a mixing ratio (parts by mass) of the thermoplastic elastomer to 100 parts by mass of the polyethylene-based resin and Y represents a stretch magnification (times).

### INDUSTRIAL APPLICABILITY

The present invention is suitably applicable to, for example, a personal care product such as a diaper.

1. A stretched porous film comprising a resin composition, the resin composition containing:
a polyethylene-based resin having a density of not less than 0.900 g/cm³ and not more than 0.940 g/cm³;
not less than 1.0 parts by mass and not more than 16 parts by mass of a thermoplastic elastomer relative to 100 parts by mass of the polyethylene-based resin; and
an inorganic filler, the stretched porous film having a water vapor transmission rate of not less than 1400 g/m²·24 h as measured at 40° C. and at a relative humidity of 60% in accordance with ASTM E96.

2. The stretched porous film as set forth in claim 1, wherein the thermoplastic elastomer is an olefin-based elastomer and/or a styrene-based elastomer.

3. The stretched porous film as set forth in claim 1, wherein the stretched porous film has a strength in a machine direction of not less than 0.3 N/25 mm and not more than 2.5 N/25 mm as measured when pulling the stretched porous film in the machine direction in accordance with HS K 7127 with a chuck-to-chuck distance of 50 mm and at a pulling speed of 200 mm/min has increased the chuck-to-chuck distance by 5%.

4. The stretched porous film as set forth in claim 1, wherein the resin composition has a melt mass flow rate of not less than 2.0 g/10 min as measured at 190° C. in accordance with JIS K 7210.

5. The stretched porous film as set forth in claim 1, wherein the stretched porous film has an air permeability of not less than 300 sec/100 ml and not more than 2000 sec/100 ml as measured by Oken-type air permeability tester method in accordance with JIS P 8117.

6. The stretched porous film as set forth in claim 1, wherein the resin composition further contains a paraffin-based oil.

7. A method for producing a stretched porous film, comprising:
a mixing step of mixing (i) a polyethylene-based resin having a density of not less than 0.900 g/cm³ and not more than 0.940 g/cm³, (ii) not less than 1.0 parts by mass and not more than 16 parts by mass of a thermoplastic elastomer relative to 100 parts by mass of the polyethylene-based resin, and (iii) an inorganic filler to prepare a resin composition;
a forming step of forming the resin composition into the form of a film; and
a porosification step of stretching, at least in a machine direction, the film obtained by the forming step to porosify the film.

8. The method as set forth in claim 7, wherein a stretch magnification at which the film is stretched in the machine direction in the porosification step is represented by the following formula II:
1.4≤Y≤0.075X+2.5 (II)
where X represents a mixing ratio (parts by mass) of the thermoplastic elastomer to 100 parts by mass of the polyethylene-based resin and Y represents a stretch magnification (times).
